(19) United States
(12) Patent Application Publication
(10) Pub. No.: US 2011/0175903 A1
(43) Pub. Date: Jul. 21, 2011

(54) SYSTEMS FOR GENERATING AND DISPLAYING THREE-DIMENSIONAL IMAGES AND METHODS THEREFOR

(75) Inventors: James F. Munro, Walworth, NY (US); Kevin J. Kearney, Fairport, NY (US); Jonathan J. Howard, Las Vegas, NV (US)

(73) Assignee: QUANTUM MEDICAL TECHNOLOGY, INC., West Bloomfield, NY (US)

(21) Appl. No.: 12/808,670

(22) PCT Filed: Dec. 18, 2008
(86) PCT No.: PCT/US2008/087440

§ 371 Date: Apr. 5, 2011

Related U.S. Application Data
(60) Provisional application No. 61/015,622, filed on Dec. 20, 2007.

(51) Int. Cl. G06T 15/00

(52) U.S. Cl. 345/419

(57) ABSTRACT

A disclosure is provided for devices, systems and methods directed to viewing 3D images. The system comprises a head mounted display; a position sensor for sensing a position of the head mounted display; a rendering engine for rendering an image based on information from the position sensor which is from a viewer's perspective; and a transmitter for transmitting the rendered image to the head mounted display.

### CROSS-REFERENCE

This application claims the benefit of U.S. Provisional Application No. 61/015,622, filed Dec. 20, 2008, which application is incorporated herein by reference.

### FIELD OF THE INVENTION

The present invention relates to a system and method for generating and displaying three-dimensional imagery that change in accordance with the location of the viewer.

### BACKGROUND OF THE INVENTION

Presently there are two aspects of head-mounted 3D (HMD) displays that are objectionable to the user and are hindering their adoption into widespread use. One problem is where wires are needed to connect the HMD to the source of imagery, over which the images are sent from a source to the HMD. These wires prove cumbersome, reduce freedom of movement of the use, and are prone to failure.

Secondly, when it is possible to navigate through a complex virtual three-dimensional (3D) image, a hand-operated input device, such as a mouse or joystick, is needed to direct the computer where the user wishes to move. In this case one or both hands are busy and are not available for other interactive activities within the 3D environment.

The present invention overcomes both of these objectionable interactive 3D viewing problems by replacing the dedicated wires with an automatic radio communication system, and by providing a six degree of freedom position and attitude sensor alongside the HMD at the viewer's head, whose attitude and position information is also sent wirelessly to a base station for controlling the viewed 3D imagery.

Accordingly, the present invention provides systems, devices and methods for sensing the position and attitude of a viewer, and generating and displaying three-dimensional images on the viewer's head mounted display system in accordance with the viewer's head position and attitude.

### SUMMARY OF THE INVENTION

The present invention for generating and displaying three-dimensional (3D) images comprises two main devices: a base-station and a head-mounted system that comprises a head-mounted-display (HMD) and a location sensing system. The 3D images are generated at the base station from tri-axial image information provided by external sources, and viewer head location provided by the location sensing system located on the head-mounted system. The 3D imagery generated by the base-station is transmitted wirelessly to the head-mounted system, which then decomposes the imagery into a left-eye image and a right-eye stereoscopic image. These images are then displayed on the two near-eye displays situated on the HMD. The location sensing system provided alongside the HMD on the head-mounted system determines the viewer's position in X, Y, Z coordinates, and also yaw, pitch, and roll, and encodes and transmits this information wirelessly to the base-station. The base station subsequently uses this information as part of the 3D image generation process.

An aspect of the invention is directed to a system for viewing 3D images. The system includes, for example, a head mounted display; a position sensor for sensing a position of the head mounted display; a rendering engine for rendering an image based on information from the position sensor which is from a viewer's perspective; and a transmitter for transmitting the rendered image to the head mounted display. Images rendered by the system can be stereoscopic, high definition images, and/or color images. In another aspect of the system, the transmitter transmits a rendered image at a video frame rate. Moreover, in some aspects, the position sensor is further adapted to sense at least one of a pitch, roll, and yaw sensor. In other aspects, the position sensor is adapted to sense a position in a Cartesian reference frame. Some embodiments of the system are configured such that the position sensor transmits a sensed position wirelessly to the rendering engine. Additionally, the rendering engine can be configured to create a stereoscopic image from a single 3D database. In some aspects, the image output from the rendering engine is transmitted wirelessly to the head mounted display. Additionally, the input into the 3D image database can be achieved by, for example, a video camera. Typically, the rendered image is an interior of a mammalian body. However, as will be appreciated by those skilled in the art, the rendered image can vary based on a viewer position; such as a view position relative to the viewed target. Moreover, the rendering engine renders the image based image depth information.

Another system, according to the invention, includes, for example, a means for mounting a display relative to a user; a means for sensing a position of the mounted display; a means for rendering an image based on information from the position sensor which is from a viewer's perspective; and a means for transmitting the rendered image to the head mounted display. Images rendered by the system can be stereoscopic, high definition images, and/or color images. In another aspect of the system, the means for transmitting transmits a rendered image at a video frame rate. Moreover, in some aspects, the position sensor is further adapted to sense at least one of a pitch, roll, and yaw sensor. In other aspects, the means for sensing a position is adapted to sense a position in a Cartesian reference frame. Some embodiments of the system are configured such that the means for sensing a position transmits a sensed position wirelessly to the rendering engine. Additionally, the means for rendering can be configured to create a stereoscopic image from a single 3D database. In some aspects, the image output from the means for rendering is transmitted wirelessly to the head mounted display. Additionally, the input into the 3D image database can be achieved by, for example, a video camera. Typically, the rendered image is an interior of a mammalian body. However, as will be appreciated by those skilled in the art, the rendered image can vary based on a viewer position; such as a view position relative to the viewed target. Moreover, the means for rendering renders the image based image depth information.

Another aspect of the invention is directed to a method for viewing 3D images. The method of viewing includes, for example, deploying a system for viewing 3D images comprising a head mounted display, a position sensor for sensing a position of the head mounted display, a rendering engine for rendering an image based on information from the position sensor which is from a viewer's perspective, and a transmitter for transmitting the rendered image to the head mounted display; sensing a position of the head mounted display; rendering an image; and transmitting the rendered image. Additionally, the method can comprise one or more of varying the rendered image based on a sensed position; rendering the image stereoscopically; a high definition image; rendering a color image. Moreover, the method can comprise one or more of transmitting the rendered image at a video frame rate; sensing at least one of a pitch, roll, and yaw; and sensing a position in a Cartesian reference frame. Furthermore, the method can additionally comprise one or more of transmitting a sensed position wirelessly to the rendering engine; creating a stereoscopic image from a single 3D database; transmitting the image output from the rendering engine wirelessly to the head mounted display; inputting the 3D image into a database, such as an input derived from a video camera. The rendered image can be an image of an interior of a mammalian body, or any other desirable target image. Moreover, the image rendering can be varied based on a viewer position; and/or depth information.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram of a 3D display-system in accordance with the present invention;

FIG. 2 is a flowchart that illustrates the processing within the 3D display system in accordance with the present invention;

FIG. 3 is diagram illustrating the integration of a 3D display system in the medical procedure environment; and

FIGS. 4A-E illustrate a near eye display system.

### DETAILED DESCRIPTION OF THE INVENTION

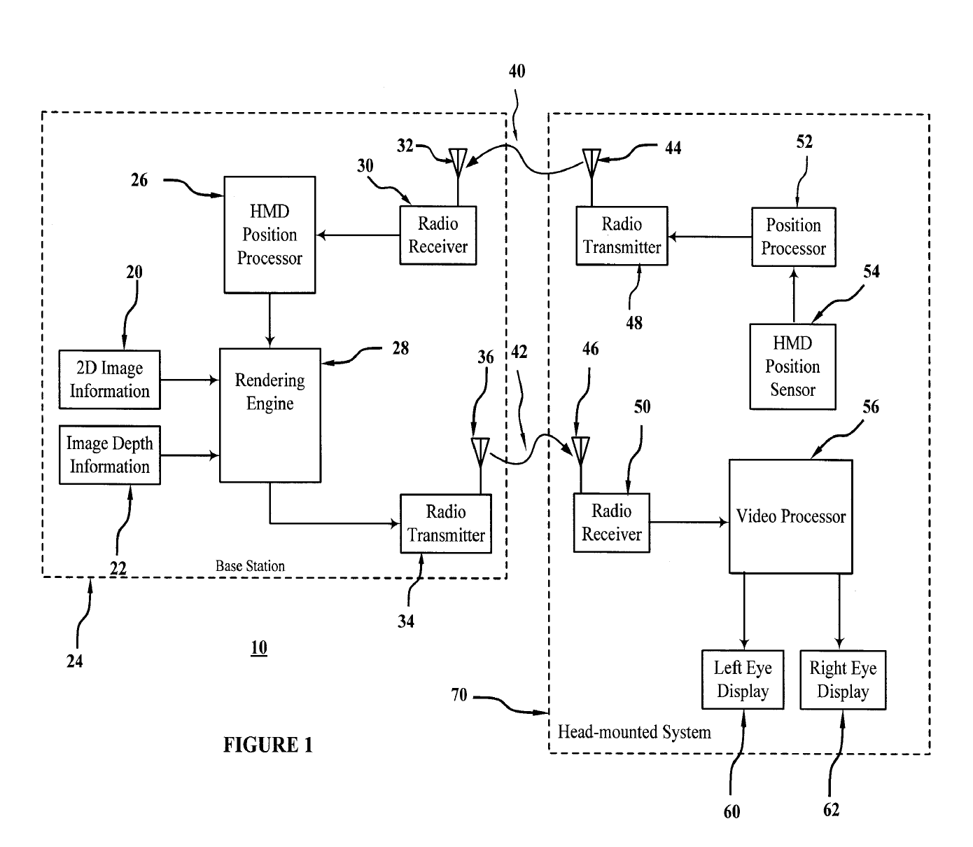

Referring to FIG. 1, the present invention 10 comprises a head mounted system 70 and a base station 24. Within the base station 24 can include several functional blocks, including, for example, a data repository 20 for the source two-dimensional (2D) image information, a data repository 22 for source image depth information, a radio antenna 32 and radio receiver 30 that act cooperatively to receive and demodulate a viewer's viewing position from the head-mounted system, a position processor 26 that processes the demodulated viewer position information and reformats it for use by the rendering engine 28 which takes the viewer position information, the image depth information and the viewer head position information and creates a virtual 3D image that would be seen from the viewers point of view, and transmits this 3D image information to the head-mounted system 70 over a radio transmitter 34 and antenna 36.

Still referring to FIG. 1, the head-mounted system, as shown, comprises a position sensor 54, a position processor 52 which reformats the information from the position sensor 54 into a format that is suitable for transmission to the base station 24 over radio transmitter 48 and antenna 44. Other configurations are possible without departing from the scope of the invention. The head mounted system 70 also comprises a head-mounted-display subsystem which is composed of an antenna 46 and radio receiver 50 which act to cooperatively to receive and demodulate 3D image information transmitted by the base station 24, a video processor 56 which converts the 3D image information into a pair of 2D images, one of which is sent to a near-eye display 60 for the left eye and the second is sent to a near eye display 62 for the right eye.

The head mounted position sensor 54 can be, for example, a small electronic device located on the head-mounted subsystem 70. The position sensor can be adapted and configured to sense the viewer's head position, or to sense a change in head position, along a linear X, Y, Z coordinate system, as well as the angular coordinates, or change in angular positioning, of roll, pitch, and yaw of the viewer, and as such can have six measurable degrees of freedom, although other numbers can be used. The output can be, for example, an analog or binary signal that is sent to an input of the position processor 52.

The position processor 52 can also be a small electronic device located on the head-mounted subsystem 70. The position processor can further be adapted and configured to, for example, take position information from the head mounted position sensor 54, and convert that information into a signal that can be transmitted by a radio transmitter 48. Specifically, for example, the input head-position information will be in a binary format from the position sensor 54, and this information is then encoded with forward error correction coding information, and converted to an analog signal of the proper amplitude for use by the radio transmitter 48.

The radio transmitter 48 can also be a small electronic device located within the head mounted system 70. The radio transmitter can further be adapted and configured to take, as input, the analog signal output by the position processor 52, and modulate the signal onto a carrier of the proper frequency for use by a transmitter antenna. The modulation method can, for example, be phase-shift-keying (PSK), frequency-shift-keying (FSK), amplitude-shift-keying (ASK), or any variation of these methods for transmitting binary encoded data over a wireless link. The carrier frequency can, for example, be in the high frequency (HF) band (˜3-30 MHz; 100-10 m), very high frequency (VHF) band (˜30-300 MHz; 10-1 m), ultra high frequency (UHF) band (˜300-3000 MHz; 1 m-10 cm), or even in the microwave or millimeter wave band. Alternately an optical carrier can be used in which case the radio transmitter 48 and antenna 44 would be replaced with a light-emissive device such as an LED, and a lens.

Regardless of the type of carrier, a wireless signal 40 carrying the head position information is sent from the head mounted system 70 to the base station 24.

At the base station 24, a receive antenna 32 and receiver 30 are provided to receive and demodulate the wireless signal 40 that is being transmitted from the head mounted system 70 that carries the head positional information. The receive antenna 32 intercepts some of the wireless signal 40 and converts it into electrical energy, which is then routed to an input of the receiver 30. The receiver 30 then demodulates the signal whereby the carrier is removed and the raw head position information signal remains. This head position information may, for example, be in a binary format, and still have the forward error correction information encoded within it.

The head position information signal output by the receiver 30 is then routed to an input of the head-mounted display position processor 26. The HMD position processor 26 is a digital processor such as a microcomputer, that takes as input the head-mounted display position information signal from the receiver 30, performs error correction operations on it to correct any bits of data that were corrupted during wireless transmission 40, and then extracts X, Y, Z and yaw, roll, pitch information and stores it away for use by the rendering engine 28.

The rendering engine 28 is a digital processor that executes a software algorithm that creates a 3D virtual image from three sources of data: 1) a 2D conventional image of the target scene, 2) a target scene depth map which, and 3) viewer position information.

The 2D conventional image is an array of pixels onto which the target scene is imaged and digitized into a binary format suitable for image processing. The 2D image of the target scene is typically captured under white light illumination, and can be a still image, or video. The 2D image can be in color, or monochrome. The size and/or resolution can be from video graphic array (VGA) (640×480 pixels), to television (TV) high definition (1920×1080 pixels), or higher. This 2D image information is typically stored in a bitmapped file, although other types of formats can be used, and stored in the 2D image information repository 20 for use by the rendering engine 28.

The target scene depth map is also an array of pixels in which is stored the depth information of the target scene (instead of reflectance information for the 2D image discussed previously). The target scene depth map is obtained by the use of a range camera, or other suitable mechanism, such as by the use of structured light, and is nominally of the same size as the 2D image map so there is a one to one pixel correspondence between the two types of image maps. Furthermore, the image depth information can be a still depth image, or it can be a time-varying depth video. In any event, the depth information and the 2D image information must both be captured at substantially the same point in time to be meaningful. After collection, the latest target scene depth map is stored in the image depth repository 22 for use by the rendering engine 28.

The viewer position information output from the HMD position processor 26 is input to the rendering engine 28 as mentioned earlier. This information must be in real-time, and be updated and made available to the rendering engine 28 at substantially the same time that the target scene depth and 2D image information become available. Alternately, the real-time head position information can be coupled by the rendering engine with static target scene depth information and static 2D image information, so that a non-time-varying 3D scene can be viewed by the viewer from different virtual positions and attitudes in the viewing space. However, if the real-time head position information is coupled by the rendering engine with dynamic (e.g., video) target scene depth information and dynamic (e.g., video) 2D image information, then a dynamic 3D scene can be viewed in real-time by a viewer from different virtual positions.

The virtual 3D image created by the rendering engine 28 can be encoded with a forward error correction algorithm, formatted into a serial bit-stream, which is then output by the rendering engine 28. This serial bit-stream is then routed to an input of a radio transmitter 34 which modulates the binary data onto a carrier of the proper frequency for use by the transmitter antenna 36. The modulation method can then be phase-shift-keying (PSK), frequency-shift-keying (FSK), amplitude-shift-keying (ASK), or any variation of these methods for transmitting binary encoded data over a wireless link. The carrier frequency can be in the HF band, VHF band, UHF band, or even in the microwave or millimeter wave band. Alternately an optical carrier can be used in which case the radio transmitter 34 and antenna 36 would be replaced with a light-emissive device such as an LED and a lens.

Regardless of the type of carrier, a wireless signal 42 carrying the virtual image information is sent from the base station 24 to the head mounted system 70.

At the head-mounted system 70, a small receive antenna 46 and receiver 50 are provided to receive and demodulate the wireless signal 42 that is being transmitted from the base station 24 that carries the virtual image information. The receive antenna 46 intercepts some of the wireless signal 42 and converts it into electrical energy, which is then routed to an input of the receiver 50. The receiver 50 then demodulates the signal whereby the carrier is removed and the raw 3D image information signal remains. This image information is in a binary format, and still has the forward error correction information encoded within it.

The demodulated 3D image information output by the radio receiver 50 is routed to an input of the video processor 56. The video processor 56 is a small electronic digital processor, such as a microcomputer, which, firstly, performs forward error correction on the 3D image data to correct any bits of image data that were corrupted during wireless transmission 42, and then, secondly, algorithmically extracts two stereoscopic 2D images from the corrected 3D image. These two 2D images are then output by the video processor 56 to two near-eye 2D displays, 60 and 62.

Provided on the head-mounted system are two small near-eye displays: one for the left eye 60, and a second for the right eye 62. The pixel size of each of these 2D displays is nominally the same as the size of the image map information stored in the 2D image repository 20 and the image depth repository 22, such as VGA (640×480 pixels) or TV high definition (1920×1080 pixels). Each display will present a slightly different image of the target scene to their respective eye, so that the virtual stereoscopic imagery is interpreted as being a 3D image by the brain. These two slightly different images are generated by the video processor 56. Typically a small lens system is provided as part of the display subsystem so that the display-to-eye distance can be minimized, but yet so that the eye can comfortably focus on such a near-eye object. The displays 60 and 62 themselves can be conventional liquid crystal display (LCD), or even be of the newer organic light emitting device (OLED) type.

As will be appreciated by those skilled in the art, the above discussion is centered upon 3D imaging wherein a 3D image is generated at the base station 24 by the rendering engine 28, and this 3D image is transmitted wirelessly to the head-mounted system 70 where the 3D image is split into two 2D images by the video processor 56. An alternate approach is also contemplated. For example, the rendering engine 28 can be adapted and configured to create two 2D images, which are sequentially transmitted wirelessly to the head-mounted system 70 instead of the 3D image. In this case, it is expected that the demands on the video processor 56 would be much simpler as it no longer needs to split a 3D image into two stereoscopic 2D images, although the video processor 56 still needs to perform forward error correction operations.

Furthermore, the above discussion is also centered upon a wireless embodiment wherein the position and attitude information of the head-mounted system 70 and the 3D image information generated within the base station 24 are sent wirelessly between the head-mounted system 70 and the base station 24 through radio receivers 30 and 50, radio transmitters 48 and 34, through antennae 32, 44, 36, and 46, and over wireless paths 40 and 42. In applications where cost must be minimized, and/or where wires between the head-mounted system 70 and base station 24 are not problematic, the wireless aspects of the present invention can be dispensed with. In this case the output of the position processor 52 of the head-mounted system 70 is connected to an input of the head-mounted position processor 26 of the base station so that the head position and attitude information is routed directly to the HMD position processor 26 from the head-mounted position processor 52. Also, an output of the rendering engine 28 is connected to an input of the video processor 56 at the head-mounted system 70 so that 3D imagery created by the rendering engine 28 is sent directly to the video processor 56 of the head-mounted system 70.

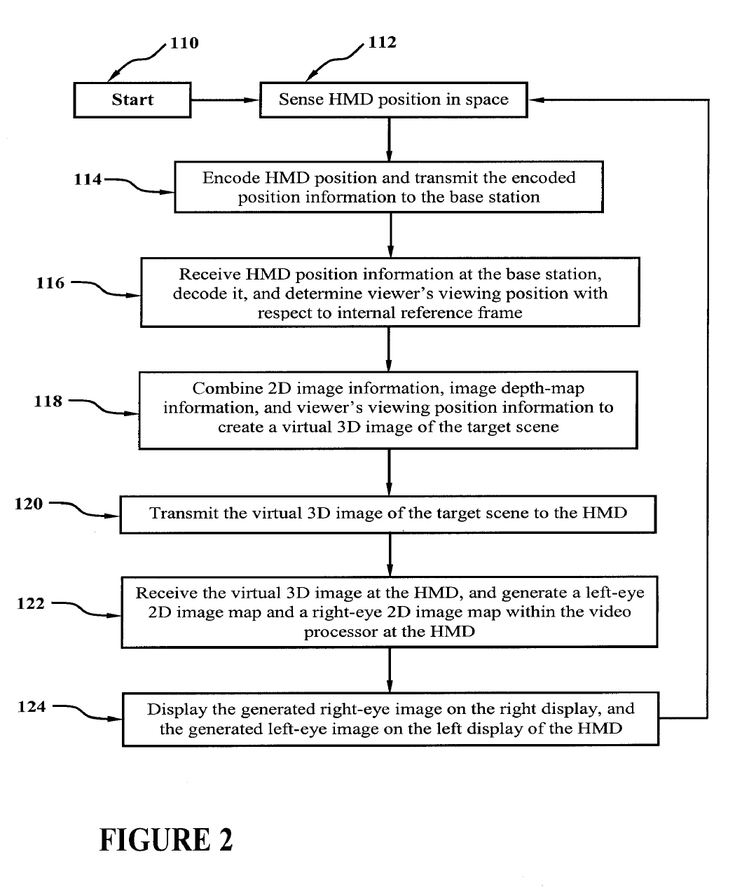

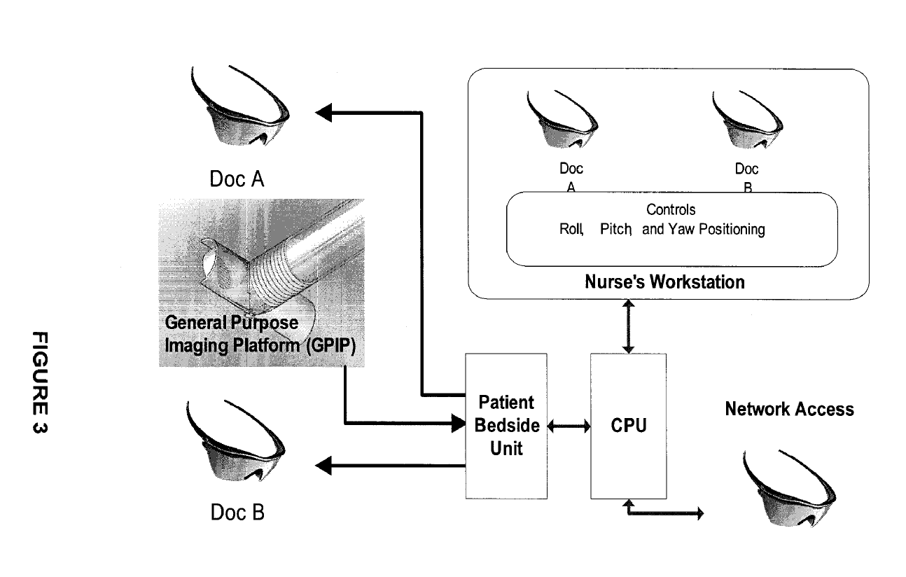

Turning now to FIG. 2, an example of an operation is provided. At the start 110 of the operation of displaying a position-dependent 3D image, the position of the head-mounted system 70 is first determined at step 112. The position sensor senses attitude and positional information, or change in attitude and positional information. At process step 114, the position and attitude information is then encoded for forward-error-correction, and transmitted to a base-station 24.

Next, at process step 116 the position and attitude information of the head-mounted system is decoded by the HMD position processor 26, which then formats the data, (including adding in any location offsets so the position information is consistent with the reference frame of the rendering engine 28) for subsequent use by rendering engine 28.

Next at process step 118 the rendering engine 28 combines the 2D target scene image map, the target scene depth map, the location information of the viewer, and the attitude information or me viewer, and generates a virtual 3D image that would be seen by the viewer at the virtual location and angular orientation of the viewer.

Next at process step 120 the virtual 3D image created by the rendering engine 28 is transmitted from the base station 24 to the head-mounted system 70. At 122 the received 3D image is routed to the video processor 56 which then splits the single 3D image map into two 2D stereoscopic image maps. These two 2D displayable images are presented to a right-eye display 62, and a left-eye display 60 in process step 124.

The applications for such a system are numerous, and include but are not limited to surgery, computer games, hands-free operation of interactive videos, viewing 3D images sent over the internet, remote diagnostics, reverse engineering, and others.

FIG. 3 illustrates a system whereby a patient bedside unit, configured to obtain biologic information from a patient, is in communication with a central processing unit (CPU) which may also include network access—thus allowing remote access to the patient via the system. The patient bedside unit is in communication with a general purpose imaging platform (GPIP) and one or more physicians or healthcare practitioners can be fitted with a head mounted system that interacts with the general purpose imaging platform and/or patient beside unit and/or CPU as described above.

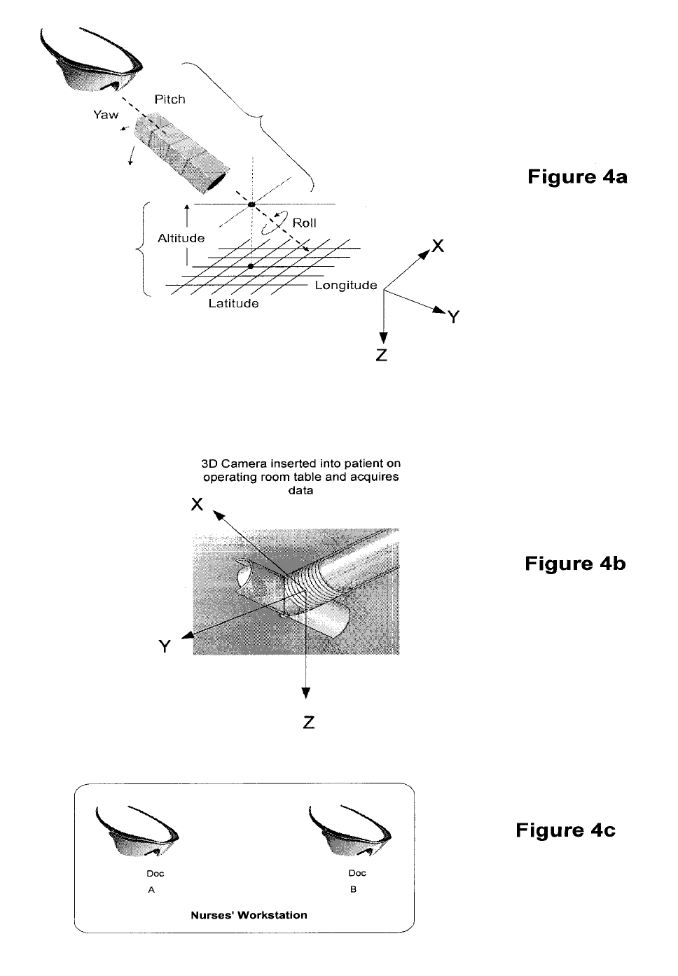

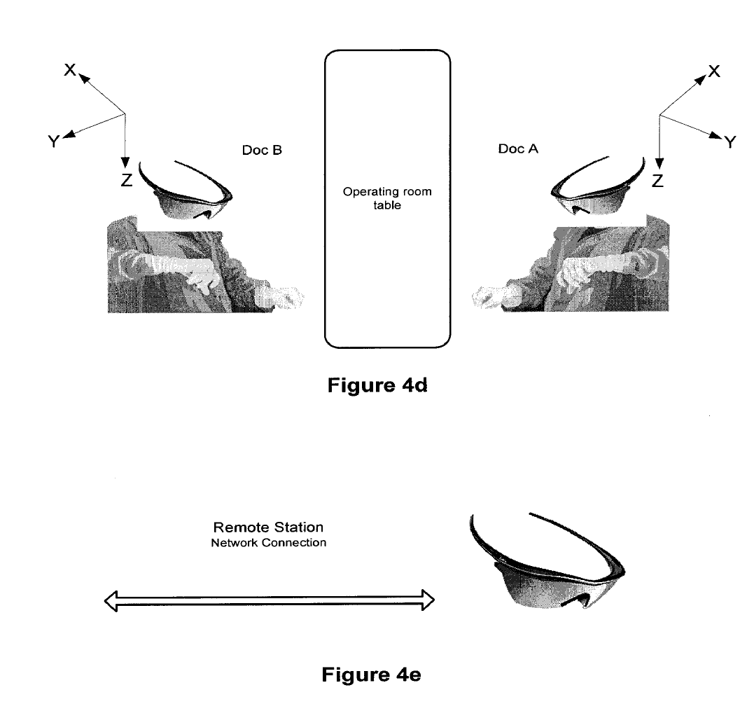

Turning now to FIGS. 4A-E, a video near eye display is provided with motion sensors adapted to sense motion in an X, Y and Z axis. Once motion is sensed by the motion sensors, the sensors determine a change in position of the near eye display in one or more of an X, Y, or Z axis and transmit one or more of the change in position, or a new set of coordinates. The near eye display then renders an image in relation to the target and the desired viewing angle from the information acquired from the sensors. As shown in FIG. 4B, a 3D camera is inserted into a patient on, for example, an operating room table. The camera then acquires video of an X-Y image and Z axis topographic information. A nurses workstation, FIG. 4c, can then provide remote control course or fine adjustments to the viewing angle and zoom of one or more doctors near eye display devices. This enables the doctors to concentrate on subtle movements, as depicted in FIG. 4D. The doctors near eye display images are oriented and aligned to a correct position in relation to a target image and the doctor's position relative to the patient. From a remote location work station, FIG. 4E, image data can be displayed and rendered remotely using a near eye display and motion sensors.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for viewing 3D images comprising:
a head mounted display;
a position sensor for sensing a position of the head mounted display;
a rendering engine for rendering an image based on information from the position sensor which is from a viewer's perspective; and
a transmitter for transmitting the rendered image to the head mounted display.

2. The system of claim 1 wherein the image is rendered is stereoscopic.

3. The system of claim 1 wherein the image is a high definition image.

4. The system of claim 1 wherein the image is a color image.

5. The system of claim 1 wherein the transmitter transmits the rendered image at a video frame rate.

6. The system of claim 1 wherein the position sensor further senses at least one of a pitch, roll, and yaw sensor.

7. The system of claim 1 wherein the position sensor senses a position in a Cartesian reference frame.

8. The system of claim 1 wherein the position sensor transmits a sensed position wirelessly to the rendering engine.

9. The system of claim 1 wherein the rendering engine creates a stereoscopic image from a single 3D database.

10. The system of claim 1 wherein the image output from the rendering engine is transmitted wirelessly to the head mounted display.

11. The system of claim 9 wherein an input into the 3D image database is a video camera.

12. The system of claim 1 wherein the rendered image is an interior of a mammalian body.

13. The system of claim 1 wherein the rendered image varies based on a viewer position.

14. The system of claim 1 wherein the rendering engine renders the image based image depth information.

15. A method for viewing 3D images:
deploying a system for viewing 3D images comprising a head mounted display, a position sensor for sensing a position of the head mounted display, a rendering engine for rendering an image based on information from the position sensor which is from a viewer's perspective, and a transmitter for transmitting the rendered image to the head mounted display;
sensing a position of the head mounted display;
rendering an image; and
transmitting the rendered image.

16. The method of claim 15 further comprising the step of varying the rendered image based on a sensed position.

17. The method of claim 15 further comprising the step of rendering the image stereoscopically.

18. The method of claim 15 further comprising the step of rendering a high definition image.

19. The method of claim 15 further comprising the step of rendering a color image.

20. The method of claim 15 further comprising the step of transmitting the rendered image at a video frame rate.

21. The method of claim 15 further comprising the step of sensing at least one of a pitch, roll, and yaw.

22. The method of claim 15 further comprising the step of sensing a position in a Cartesian reference frame.

23. The method of claim 15 further comprising the step of transmitting a sensed position wirelessly to the rendering engine.

24. The method of claim 15 further comprising the step of creating a stereoscopic image from a single 3D database.

25. The method of claim 15 further comprising the step of transmitting the image output from the rendering engine wirelessly to the head mounted display.

26. The method of claim 15 further comprising the step of inputting the 3D image into a database

27. The method of claim 26 wherein the input is a video camera.

28. The method of claim 15 wherein the rendered image is an interior of a mammalian body.

29. The method of claim 15 further comprising the step of varying the rendered image based on a viewer position.

30. The method of claim 15 further comprising the step of rendering the image based image depth information.
